(19) United States
(12) Patent Application Publication
(10) Pub. No.: US 2015/0092764 A1
(43) Pub. Date: Apr. 2, 2015

(54) COMMUNICATION APPARATUS, DATA PROCESSING APPARATUS, CONTROL METHOD THEREOF, AND RECORDING MEDIUM

(71) Applicant: CANON KABUSHIKI KAISHA, Tokyo (JP)

(72) Inventor: Eiko Hirose, Tokyo (JP)

(21) Appl. No.: 14/498,631

(22) Filed: Sep. 26, 2014

(30) Foreign Application Priority Data
Oct. 2, 2013 (JP) 2013-207012

(51) Int. Cl. H04W 36/14; H04W 36/08; H04W 4/00

(52) U.S. Cl. CPC H04W 36/14; H04W 4/008; H04W 36/08
USPC 370/338

(57) ABSTRACT

A communication apparatus establishes communication with a data processing apparatus via a first network created by the data processing apparatus, receives an instruction to transmit data to an external apparatus different from the data processing apparatus after the communication with the data processing apparatus is established, transmits, to the data processing apparatus, a notification for terminating the communication with the data processing apparatus and a notification for causing the data processing apparatus to continue the first network, if the instruction is received, and establishes communication with the external apparatus via a second network after the communication with the data processing apparatus is terminated.

### BACKGROUND OF THE INVENTION

1. Field of the Invention

The present invention relates to a technique for communicating with another apparatus via a network.

2. Description of the Related Art

There has been known a technique for providing a wireless communication function to a data processing apparatus such as a digital camera, and transmitting image data stored in the data processing apparatus to an external apparatus (Japanese Patent Application Laid-Open No. 2007-166577). Further, in recent years, there have been known data processing apparatuses such as digital cameras that are provided with a simple access point function. When the digital camera activates the simple access point, another apparatus detects the digital camera as an access point and participates in a network created by the digital camera, which allows the digital camera and the other apparatus to easily communicate with each other.

Generally, the digital cameras or other similar apparatuses do not have a line for connecting to a public network or the like, unlike relay apparatuses such as commonly-used access points. Accordingly, even participation in the network created by the simple access point does not allow the other apparatus to communicate with an external network, such as the Internet. The network connection should be switched from the network created by the simple access point to another network to allow the other apparatus to communicate with the external network.

Therefore, when the other apparatus needs to use the external network, such as the Internet, one possible method for dealing with this is to perform control in such a manner that the network connection is temporarily switched from the network created by the simple access point to the other network. However, once the other apparatus leaves the network created by the simple access point, the network created by the simple access point may be determined to be unnecessary and therefore may be deleted, for example. In this case, after the end of the communication via the external network, the other apparatus cannot participate in the network created by the simple access point function again.

### SUMMARY OF THE INVENTION

According to an aspect of the present invention, a communication apparatus includes a unit configured to establish communication with a data processing apparatus via a first network created by the data processing apparatus, a receiving unit configured to receive an instruction to transmit data to an external apparatus different from the data processing apparatus after the communication with the data processing apparatus is established, a transmission unit configured to transmit, to the data processing apparatus, a notification for terminating the communication with the data processing apparatus and a notification for causing the data processing apparatus to continue the first network, if the instruction is received by the receiving unit, and a unit configured to establish communication with the external apparatus via a second network after the communication with the data processing apparatus is terminated.

Further features of the present invention will become apparent from the following description of exemplary embodiments with reference to the attached drawings.

### BRIEF DESCRIPTION OF THE DRAWINGS

FIG. 1 is a block diagram illustrating a configuration of a digital camera according to a first exemplary embodiment.

FIG. 2 is a block diagram illustrating a configuration of a mobile phone according to the first exemplary embodiment.

FIGS. 3A and 3B illustrate network configurations according to the first exemplary embodiment.

FIG. 4 is a flowchart illustrating an operation of the digital camera according to the first exemplary embodiment.

FIGS. 5A-A, 5A-B, 5A-C, 5A-D, 5A-E, and 5A-F illustrate examples of display screens according to the first exemplary embodiment.

FIGS. 5B-A and 5B-B are flowcharts illustrating operations of the mobile phone according to the first exemplary embodiment.

FIGS. 6A and 6B are flowcharts illustrating an operation of the mobile phone according to the first exemplary embodiment.

FIGS. 7A, 7B, 7C, 7D, 7E, 7F, 7G, 7H, and 71 illustrate examples of display screens according to the first exemplary embodiment.

FIG. 8 is a flowchart illustrating an operation of the digital camera according to the first exemplary embodiment.

FIGS. 9A and 9B schematically illustrate operations according to the first exemplary embodiment.

FIG. 10 schematically illustrates an operation according to the first exemplary embodiment.

FIG. 11 is a flowchart illustrating an operation of a mobile phone according to a second exemplary embodiment.

FIG. 12 is a flowchart illustrating an operation of a digital camera according to the second exemplary embodiment.

### DESCRIPTION OF THE EMBODIMENTS

### Configuration of Digital Camera

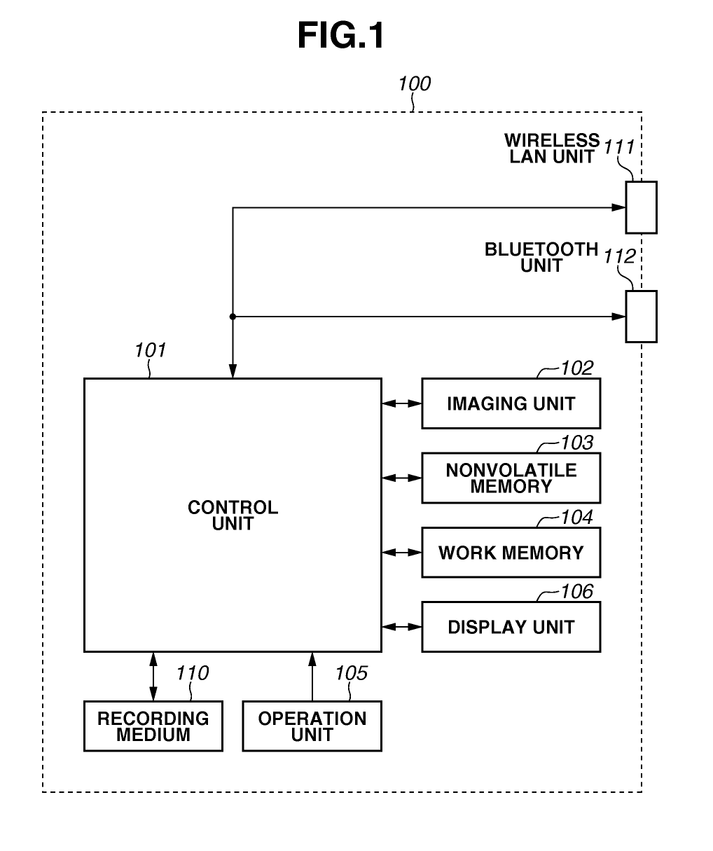

FIG. 1 is a block diagram illustrating an example of a configuration of a digital camera 100, which is an example of a data processing apparatus, according to a first exemplary embodiment. As an example of the data processing apparatus, the digital camera will be described herein, but the data processing apparatus is not limited thereto. For example, the data processing apparatus may be an information processing apparatus such as a portable media player, a so-called tablet device, and a personal computer.

A control unit 101 controls respective units of the digital camera 100 according to an input signal and a program that will be described below. A plurality of hardware devices may control the entire apparatus by dividing processing among them, instead of the control unit 101 controlling the entire apparatus.

An imaging unit 102 converts light of an object, which is imaged by a lens included in the imaging unit 102, into an electric signal, performs noise reduction processing and the like, and outputs digital data as image data. The captured image data is stored in a buffer memory, and after that, subjected to a predetermined calculation by the control unit 101 to be recorded on a recording medium 110.

A nonvolatile memory 103 is an electrically erasable and recordable nonvolatile memory, and stores, for example, the below-described program to be executed by the control unit 101.

A work memory 104 is used as the buffer memory for temporarily storing the image data captured by the imaging unit 102, a memory used when a display unit 106 displays an image, a work area of the control unit 101, and the like.

An operation unit 105 is used to receive an instruction issued from a user to the digital camera 100. The operation unit 105 includes operation members, such as a power button that allows the user to issue an instruction to power on and off the digital camera 100, a release switch that allows the user to issue an instruction to shoot an object, and a playback button that allows the user to issue an instruction to play back image data. Further, the operation unit 105 also includes a touch panel formed on the display unit 106 that will be described below. The release switch includes a switch SW1 and a switch SW2. When the release switch is half-pressed, the switch SW1 is turned on. In response thereto, the digital camera 100 receives an instruction to make preparations for shooting, such as automatic focus (AF) processing, automatic exposure (AE) processing, automatic white balance (AWB) processing, and electronic flash pre-emission (EF) processing. Further, when the release switch is fully pressed, the switch SW2 is turned on. In response thereto, the digital camera 100 receives the instruction to shoot an object.

The display unit 106 displays a viewfinder image during shooting, the captured image data, characters for an interactive operation, and the like. The display unit 106 does not necessarily have to be built in the digital camera 100. The digital camera 100 only has to be connectable to the internally or externally provided display unit 106, and have at least a display control function of controlling display of the display unit 106.

The image data output from the imaging unit 102 can be recorded on the recording medium 110. The recording medium 110 may be configured to be detachably attached to the digital camera 100, or may be built in the digital camera 100. In other words, the digital camera 100 only has to include at least a unit configured to access the recording medium 110.

A wireless local area network (LAN) unit 111 is an interface that allows the digital camera 100 to connect to an external apparatus. The digital camera 100 according to the present exemplary embodiment can exchange data with the external apparatus via the wireless LAN unit 111. The control unit 101 realizes wireless communication with the external apparatus by controlling the wireless LAN unit 111.

The digital camera 100 according to the present exemplary embodiment can operate as a slave apparatus in an infrastructure mode. When the digital camera 100 operates as a slave apparatus, the digital camera 100 can connect to an access point (hereinafter referred to as an AP) in the vicinity to participate in a network created by the AP. Further, the digital camera 100 according to the present exemplary embodiment can also operate as a simply prepared AP (hereinafter referred to as a simple AP) that is one type of AP but has further limited functions, such as a micro AP. The AP in the present exemplary embodiment is an example of a relay apparatus. When the digital camera 100 operates as the simple AP, the digital camera 100 creates a network by itself. This allows an apparatus in the vicinity of the digital camera 100 to recognize the digital camera 100 as an AP and participate in the network created by the digital camera 100. In the present exemplary embodiment, a program for causing the digital camera 100 to operate in the above-described manner is stored in the nonvolatile memory 103.

The digital camera 100 according to the present exemplary embodiment is one type of AP, but is the simple AP that does not have a gateway function of transferring data received from a slave apparatus to an Internet provider or the like. Therefore, even when the digital camera 100 receives data from another apparatus participating in the network created by the digital camera 100, the digital camera 100 cannot transfer the received data to a network such as the Internet.

A Bluetooth unit 112 is also an interface that allows the digital camera 100 to connect to an external apparatus using Bluetooth. The digital camera 100 according to the present exemplary embodiment can exchange data with the external apparatus via the Bluetooth unit 112 in a similar manner to exchanging data via the wireless LAN unit 111. The control unit 101 realizes wireless communication with the external apparatus by controlling the Bluetooth unit 112. The Bluetooth communication in the present exemplary embodiment may use Bluetooth Low Energy.

The configuration of the digital camera 100 has been described above. Next, a mobile phone 200, which is an example of the external apparatus, will be described.

### <Configuration of Mobile Phone>

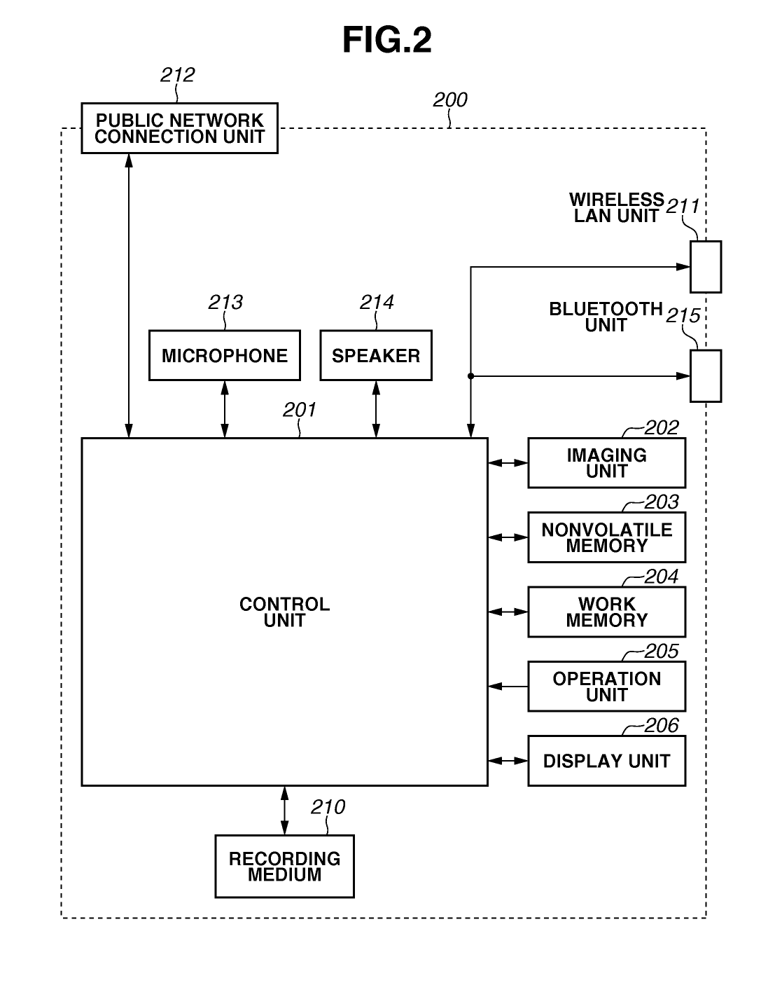

FIG. 2 is a block diagram illustrating an example of a configuration of the mobile phone 200, which is an example of a communication apparatus, according to the present exemplary embodiment. As an example of the communication apparatus, the mobile phone will be described herein, but the communication apparatus is not limited thereto. For example, the communication apparatus may be an information processing apparatus such as a digital camera having a wireless function, a portable media player, a so-called tablet device, a personal computer, and a smartphone.

A control unit 201 controls respective units of the mobile phone 200 according to an input signal and a program that will be described below. A plurality of hardware devices may control the entire apparatus by dividing processing among them, instead of the control unit 201 controlling the entire apparatus.

An imaging unit 202 converts light of an object, which is imaged by a lens included in the imaging unit 202, into an electric signal, performs noise reduction processing and the like, and outputs digital data as image data. The captured image data is stored in a buffer memory, and after that, subjected to a predetermined calculation by the control unit 201 to be recorded on a recording medium 210.

A nonvolatile memory 203 is an electrically erasable and recordable nonvolatile memory, and stores, for example, various kinds of programs to be executed by the control unit 201. In the present exemplary embodiment, a program for communicating with the digital camera 100 is also stored in the nonvolatile memory 203, and is installed as a camera communication application. Processing performed by the mobile phone 200 according to the present exemplary embodiment is realized by loading a program provided by the camera communication application. In the present exemplary embodiment, the camera communication application includes a program for using basic functions of an operating system (OS) installed in the mobile phone 200. The OS of the mobile phone 200 may include the program for realizing the processing according to the present exemplary embodiment.

A work memory 204 is used as the buffer memory for temporarily storing the image data formed by the imaging unit 202, a memory used when a display unit 206 displays an image, a work area of the control unit 201, and the like.

An operation unit 205 is used to receive an instruction issued from a user to the mobile phone 200. The operation unit 205 includes operation members, such as a power button that allows the user to issue an instruction to power on and off the mobile phone 200, and a touch panel formed on the display unit 206.

The display unit 206 displays the image data, characters for an interactive operation, and the like. The display unit 206 does not necessarily have to be built in the mobile phone 200. The mobile phone 200 only has to be connectable to the display unit 206, and have at least a display control function of controlling display of the display unit 206.

The image data output from the imaging unit 202 can be recorded on the recording medium 210. The recording medium 210 may be configured to be detachably attached to the mobile phone 200, or may be built in the mobile phone 200. In other words, the mobile phone 200 only has to include at least a unit configured to access the recording medium 210.

A wireless LAN unit 211 is an interface that allows the mobile phone 200 to connect to an external apparatus. The mobile phone 200 according to the present exemplary embodiment can exchange data with the external apparatus via the wireless LAN unit 211. The control unit 201 realizes wireless communication with the external apparatus by controlling the wireless LAN unit 211. The mobile phone 200 according to the present exemplary embodiment can operate as at least a slave apparatus in the infrastructure mode, and can participate in a network created by an AP in the vicinity.

A Bluetooth unit 215 is also an interface that allows the mobile phone 200 to connect to an external apparatus. The mobile phone 200 according to the present exemplary embodiment can exchange data with the external apparatus via the Bluetooth unit 215 in a similar manner to exchanging data via the wireless LAN unit 211. The control unit 201 realizes wireless communication with the external apparatus by controlling the Bluetooth unit 215.

A public network connection unit 212 is an interface used for performing public wireless communication. The mobile phone 200 can have a phone call and perform data communication with another apparatus via the public network connection unit 212. When the mobile phone 200 has a phone call, the control unit 201 inputs and outputs an audio signal via a microphone 213 and a speaker 214. In the present exemplary embodiment, the public network connection unit 212 includes an interface for performing communication using the third-generation mobile technology (3G). The public network connection unit 212 may use not only 3G but also another communication method, such as Long Term Evolution (LTE), Worldwide Interoperability for Microwave Access (WiMAX), Asymmetric Digital Subscriber Line (ADSL), Fiber To The Home (FTTH), and the so-called fourth-generation mobile technology (4G). Further, the wireless LAN unit 211 and the public network connection unit 212 do not necessarily have to be configured by independent hardware devices, respectively. For example, a single antenna may be used as both the wireless LAN unit 211 and the public network connection unit 212. The configuration of the mobile phone 200 has been described above.

### <Overviews of Connection Configurations>

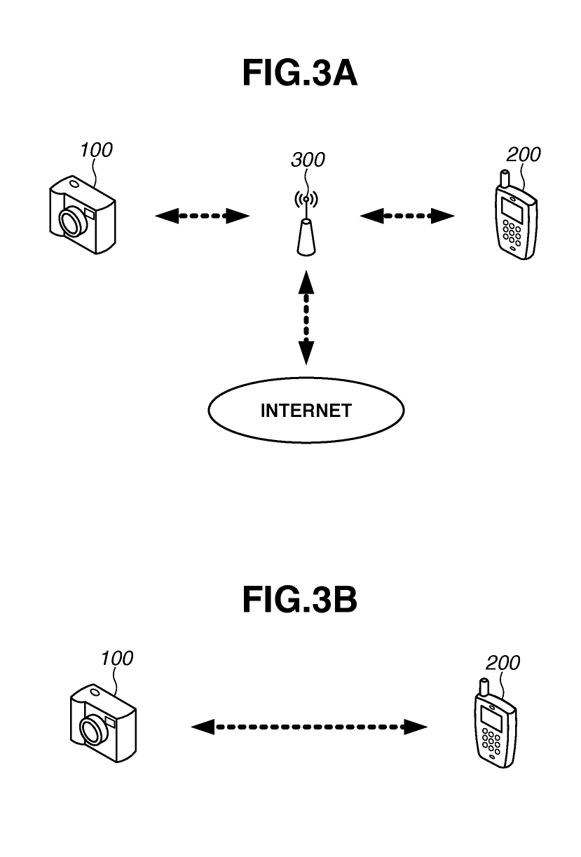

FIGS. 3A and 3B schematically illustrate connection configurations of a communication system including the digital camera 100 and the mobile phone 200 according to the present exemplary embodiment. If the digital camera 100 and the mobile phone 200 wirelessly transmit and receive data therebetween, there are two possible types of connection configurations illustrated in FIGS. 3A and 3B.

FIG. 3A illustrates a configuration in which the digital camera 100 and the mobile phone 200 participate in a wireless LAN network created by an external AP 300, which is an example of an external relay apparatus. The digital camera 100 and the mobile phone 200 detect a beacon signal periodically transmitted from the external AP 300, and participate in the wireless LAN network created by the external AP 300. After participating in the same wireless LAN network, the digital camera 100 and the mobile phone 200 become ready for data reception and transmission via the wireless LAN (establish communication between the apparatuses) through discovery of each other, detection of the capability of each other, and the like.

Further, the external AP 300 according to the present exemplary embodiment can connect to an external network, such as the Internet, by using a public network or the like. Therefore, the mobile phone 200 can transmit data onto the Internet via the external AP 300.

FIG. 3B illustrates a configuration in which the digital camera 100 and the mobile phone 200 are directly connected to each other without the external AP 300 intervening therebetween. In this case, the digital camera 100 operates as the simple AP, and creates a wireless LAN network. Upon a start of the operation as the simple AP, the digital camera 100 starts periodic transmission of a beacon signal. The mobile phone 200 detects the beacon signal, and participates in the wireless LAN network created by the digital camera 100. Then, the digital camera 100 and the mobile phone 200 establish communication therebetween through discover of each other, detection of the capability of each other, and the like, thereby becoming ready for data reception and transmission, in a similar manner to the configuration illustrated in FIG. 3A.

As described above, the digital camera 100 according to the present exemplary embodiment does not have a function of communicating with an external network, such as the Internet. Therefore, the mobile phone 200 participating in the wireless LAN network created by the digital camera 100 cannot transmit data to the Internet or the like via the simple AP.

In the above-described manner, there are two types of connection configurations between the digital camera 100 and the mobile phone 200. In the present exemplary embodiment, description will be given of an example for performing appropriate control according to these connection configurations.

### <Connection Processing>

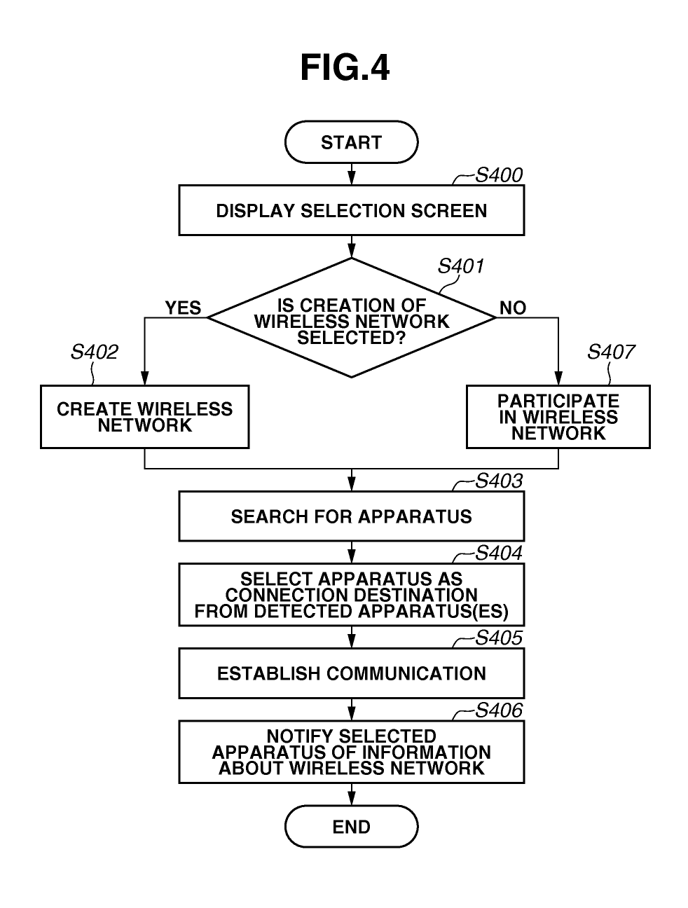

FIG. 4 is a flowchart illustrating processing that the digital camera 100 performs when connecting to the mobile phone 200. The processing illustrated in this flowchart is realized by the control unit 101 of the digital camera 100 controlling the respective units of the digital camera 100 according to an input signal and the program. The same also applies to other flowcharts illustrating processing performed by the digital camera 100, unless otherwise indicated especially. The processing illustrated in the this flowchart is started in response to an instruction that the user of the digital camera 100 issues to connect to another apparatus by performing an operation on a menu or the like.

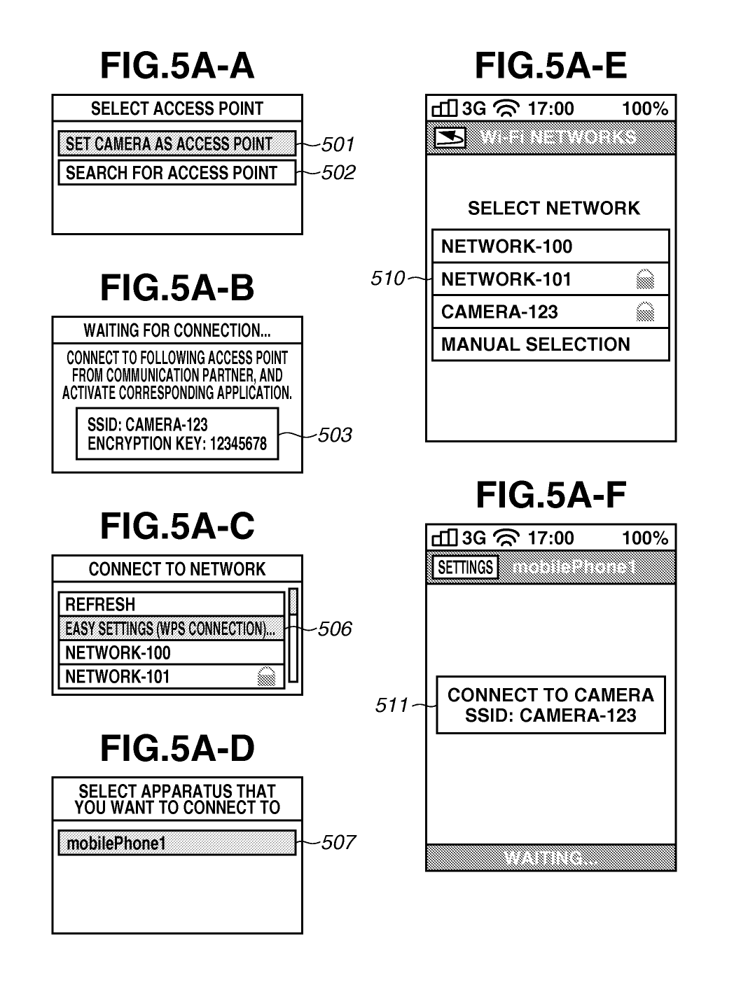

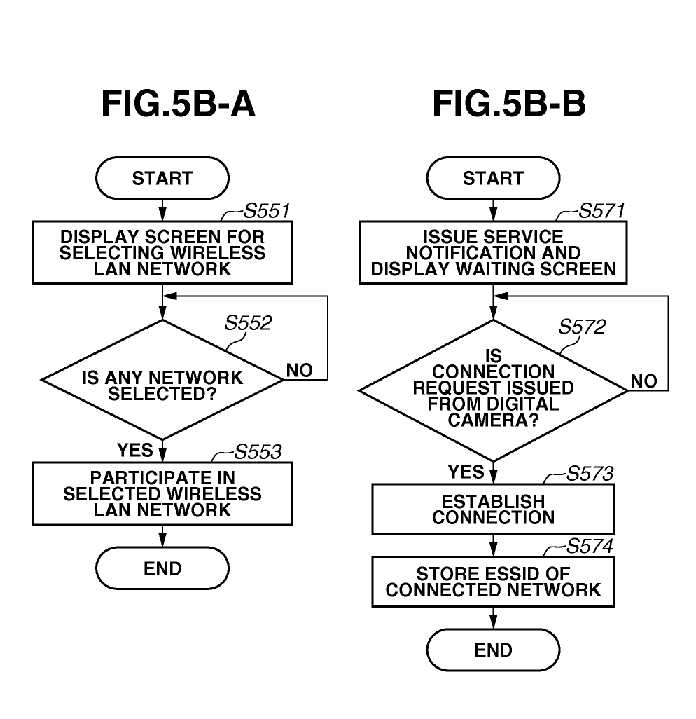

In step S400, the control unit 101 displays, on the display unit 106, a screen that prompts the user to select whether to participate in the wireless LAN network created by the external AP 300 or cause the digital camera 100 to operate as the simple AP. FIG. 5A-A illustrates an example of the screen displayed in this step.

If the control unit 101 determines that a button 501 is selected by a user operation in step S401 (YES in step S401), the control unit 101 determines that creation of a wireless LAN network is selected, and then the processing proceeds to step S402. If the control unit 101 determines that a button 502 is selected by a user operation in step S401 (NO in step S401), the control unit 101 determines that participation in the wireless LAN network created by the external AP 300 is selected, and then the processing proceeds to step S407.

In step S402, the control unit 101 creates a wireless LAN network. More specifically, the control unit 101 creates an Extended Service Set Identifier (ESSID), a Basic Service Set Identifier (BSSID), an authentication method, an encryption type, and an encryption key that are required to create the network. Further, the control unit 101 displays, on the display unit 106, at least the ESSID and the encryption key as communication parameters required for a connection apparatus to participate in the network. FIG. 5A-B illustrates an example of this display. In the example illustrated in FIG. 5A-B, the ESSID and the encryption key are determined to be “CAMERA-123” and “12345678”, respectively, as indicated in a dialog 503. The encryption key and the ESSID may be created for each connection or each connection apparatus, or may be created so as to be constantly the same. Further, in the present step, an Internet Protocol (IP) address is assigned and a subnet is set to allow the digital camera 100 to communicate with another apparatus. Then, the processing proceeds to step S403.

On the other hand, if the processing proceeds to step S407 (NO in step S401), the control unit 101 scans for a wireless LAN network in the vicinity, and displays, on the display unit 106, an ESSID included in a beacon signal detected as a result thereof in the form of a list. FIG. 5A-C illustrates an example of a screen displayed at this time. In the example illustrated in FIG. 5A-C, ESSIDs “NETWORK-100” and “NETWORK-101” are detected. Upon a selection of a wireless LAN network from a list 506 illustrated in FIG. 5A-C by a user operation, the control unit 101 participates in the selected wireless LAN network, that is, connects to the AP. Further, an IP address is assigned and a subnet is set to allow the digital camera 100 to communicate with another apparatus. Then, the processing proceeds to step S403.

In step S403, the control unit 101 searches for a connectable apparatus in the same network. A certain operation should be performed at the mobile phone 200 side to allow the mobile phone 200 to be searched for by the digital camera 100 at this time. In the following description, the operation performed at the mobile phone 200 side will be described with reference to FIGS. 5A-A through 5A-F, and FIGS. 5B-A and 5B-B. FIGS. 5B-A and 5B-B are flowcharts illustrating processing performed by the mobile phone 200 according to the present exemplary embodiment. The processing illustrated in this flowcharts is realized by the control unit 201 of the mobile phone 200 controlling the respective units of the mobile phone 200 according to an input signal and the program. The same also applies to other flowcharts illustrating processing performed by the mobile phone 200, unless otherwise indicated especially.

First, in step S551, the control unit 201 displays, on the display unit 206, a screen that prompts the user to select a wireless LAN network that the mobile phone 200 is to participate in, in response to a predetermined operation being performed by the user of the mobile phone 200. Upon the transition to this screen, the control unit 201 scans for a wireless LAN network in the vicinity, and displays a list 510 including an ESSID detected as a result thereof. FIG. 5A-E illustrates an example of the screen. In the present exemplary embodiment, a function of the OS of the mobile phone 200 performs these processes before activation of the camera communication application, but the camera communication application activated in advance may perform the processes in cooperation with a function of the OS. If the digital camera 100 is operating as the simple AP at this time, the mobile phone 200 detects the ESSID of the digital camera 100, and displays it in the list 510. In the example illustrated in FIG. 5A-E, “CAMERA-123” is displayed as the ESSID of the digital camera 100.

In step S552, the control unit 201 waits for a selection of any ESSID from the list 510. Upon a selection of any ESSID from the list 510 by a user operation (YES in step S552), the processing proceeds to step S553. If no ESSID is selected (NO in step S552), the process is repeated. In step S553, the control unit 201 participates in the corresponding wireless LAN network. This completes the participation in the network.

After the participation in the network, the user of the mobile phone 200 activates the camera communication application installed in the mobile phone 200. Processing performed by the mobile phone 200 after the camera communication application is activated will be described with reference to the flowchart of FIG. 5B-B. Main functions of the camera communication application include a function of establishing communication with a digital camera existing in the same network, a function of receiving and transmitting content data such as image data, and a function of controlling a process for transmitting content data stored in the mobile phone 200 to a server.

Upon the activation of the camera communication application based on a user operation, in step S571, a waiting screen as illustrated in FIG. 5A-F is displayed on the display unit 206. The ESSID of the network that the mobile phone 200 is currently participating in is displayed in a dialog 511. The example illustrated in FIG. 5A-F indicates a screen displayed when “CAMERA-123” is selected on the screen illustrated in FIG. 5A-E. Further, after the camera communication application is activated, the mobile phone 200 issues a notification indicating a service of the mobile phone 200 via the wireless LAN network so that the digital camera 100 can detect the mobile phone 200. The digital camera 100 can detect the mobile phone 200 based on this service notification. This service notification includes a device name and a Universally Unique Identifier (UUID) of the mobile phone 200. In step S572, the control unit 201 waits for a connection request from the digital camera 100. If the control unit 201 determines that a connection request is issued (YES in step S572), the processing proceeds to step S573. If the control unit 201 determines that no connection request is issued (No in step S572), the process is repeated. In step S573, the control unit 201 establishes communication with the digital camera 100. After that, in step S574, the control unit 201 stores the ESSID of the connected network into the work memory 204.

Referring back to FIG. 4, in step S403, the control unit 101 searches for a connectable apparatus existing in the same network. As described above, the digital camera 100 can detect the mobile phone 200 if the service notification is issued from the mobile phone 200. If the control unit 101 detects a connectable apparatus as a result of the search, the control unit 101 displays, on the display unit 106, the device name included in the service notification in the form of a list. FIG. 5A-D illustrates an example of the list display. In the example illustrated in FIG. 5A-D, a device name “mobilePhone1” is detected, as indicated in a list 507. Further, the control unit 101 associates the UUID which is also included in the service notification with the device name, and then stores them into the work memory 104.

In the present exemplary embodiment, the communication system is configured in such a manner that the device name and the UUID are included in the service notification, but may be configured in such a manner that, upon receiving the service notification, the digital camera 100 inquires of the mobile phone 200 about the device name and the UUID.

In step S404, the control unit 101 receives a user operation for selecting any apparatus among the apparatus(es) displayed in the form of a list in step S403.

In step S405, the control unit 101 transmits the connection request to the mobile phone 200 with use of the UUID of the apparatus selected in step S404, and starts establishment of communication with the selected apparatus. In the present exemplary embodiment, the digital camera 100 connects to the communication partner with use of the UUID of the communication partner, but may identify an IP address and a port number from the UUID to connect to the communication partner, or may acquire the IP address when searching for the apparatus. After the communication is established, the processing proceeds to step S406.

In step S406, the control unit 101 notifies the mobile phone 200, with which the digital camera 100 has established the communication in step S405, of whether the wireless LAN network that the mobile phone 200 is currently participating in is created by the simple AP. More specifically, if the digital camera 100 operates as the simple AP, and the mobile phone 200 participates in the wireless LAN network created by the digital camera 100, the digital camera 100 notifies the mobile phone 200 that the wireless LAN network is created by the digital camera 100. On the other hand, if the mobile phone 200 participates in a wireless LAN network created by another AP, the digital camera 100 notifies the mobile phone 200 that the wireless LAN network is not created by the digital camera 100. This notification allows the mobile phone 200 to determine whether the mobile phone 200 is currently participating in a network created by the digital camera 100 or a network created by another AP. Then, based on this notification, the mobile phone 200 can determine whether the mobile phone 200 can communicate with an external network via the wireless LAN network that the mobile phone 200 is currently participating in.

<Operation after Connection>

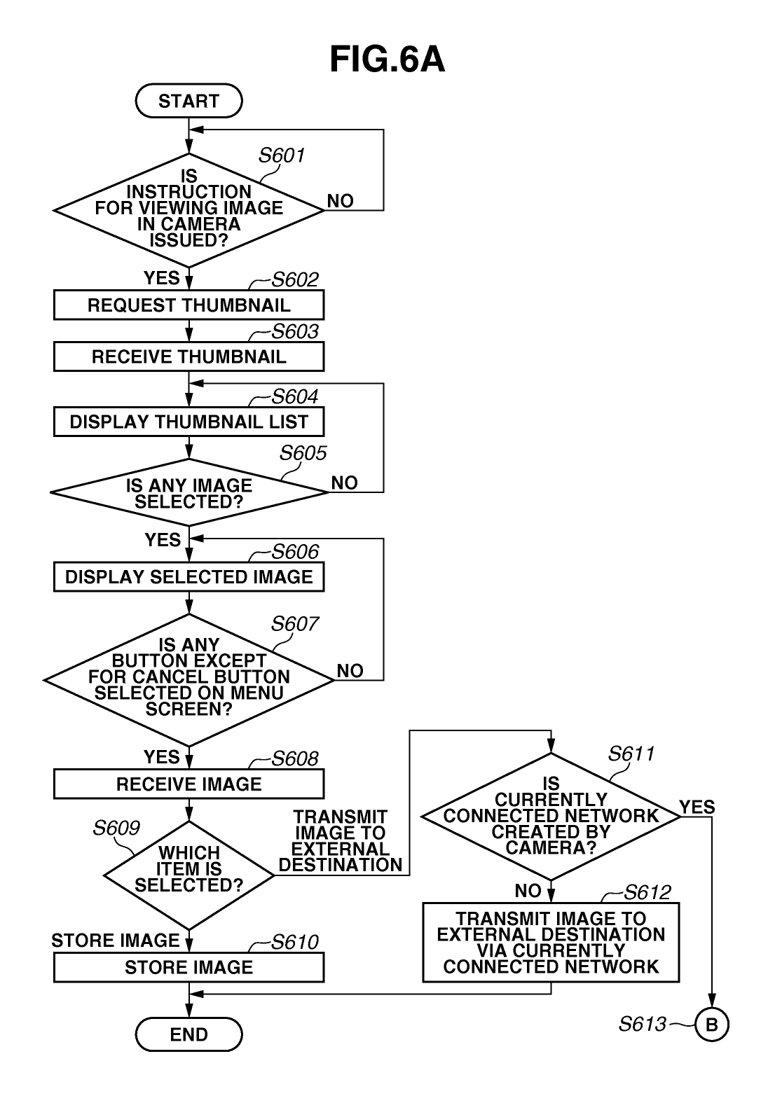

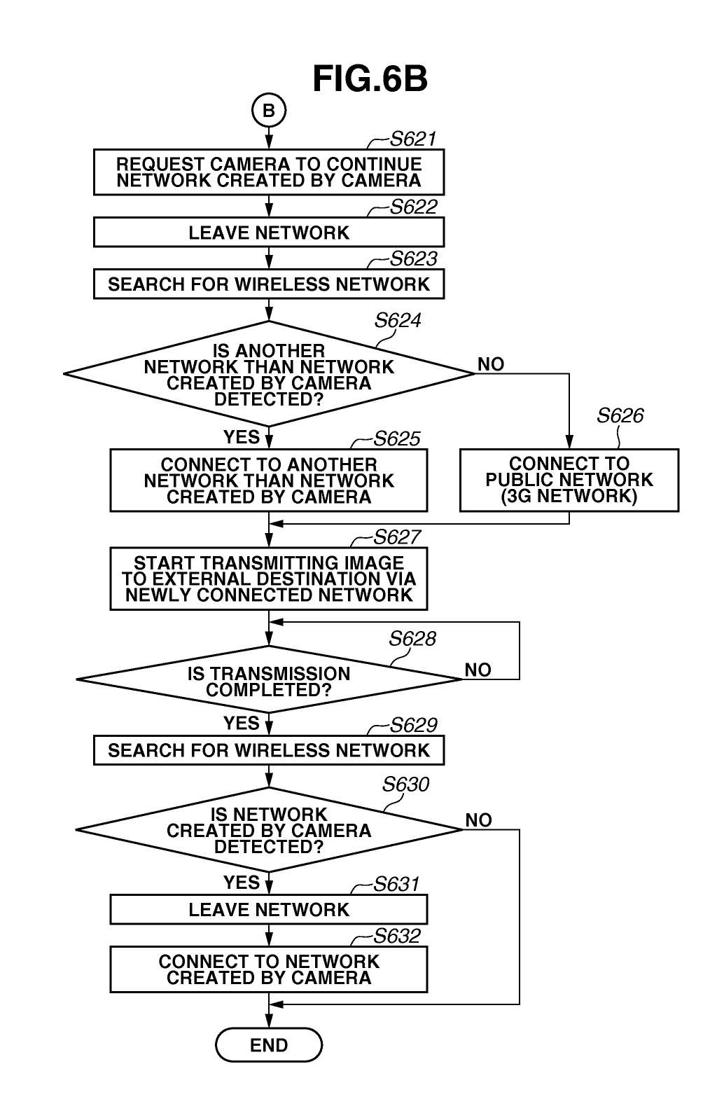

FIGS. 6A and 6B are flowcharts illustrating an operation of the mobile phone 200 after the communication with the digital camera 100 is established.

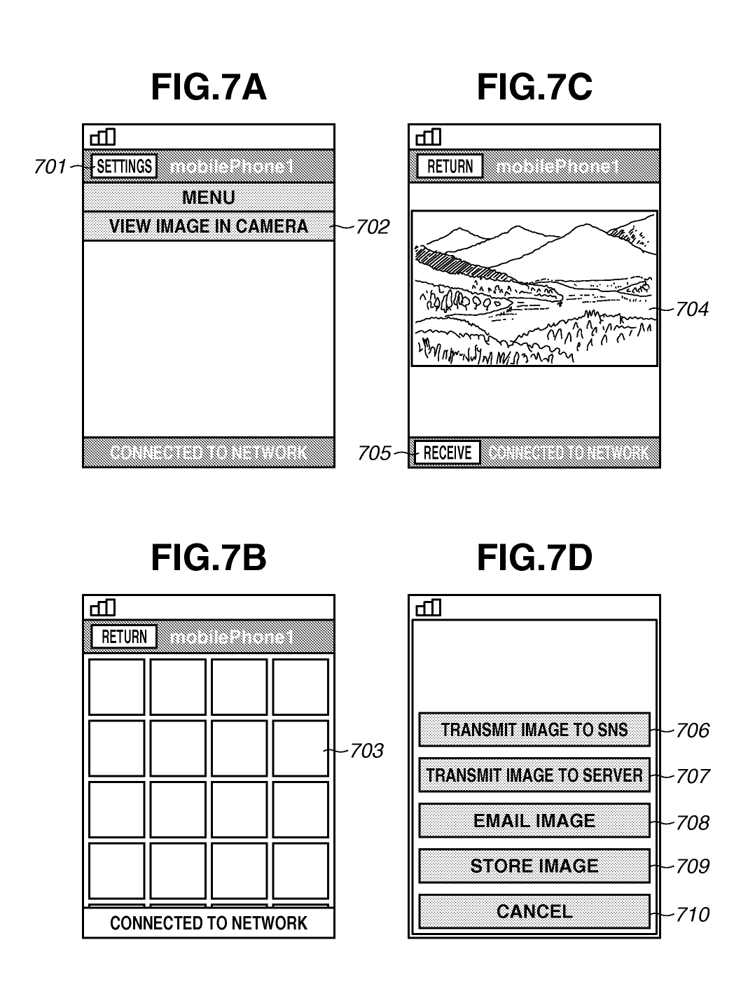

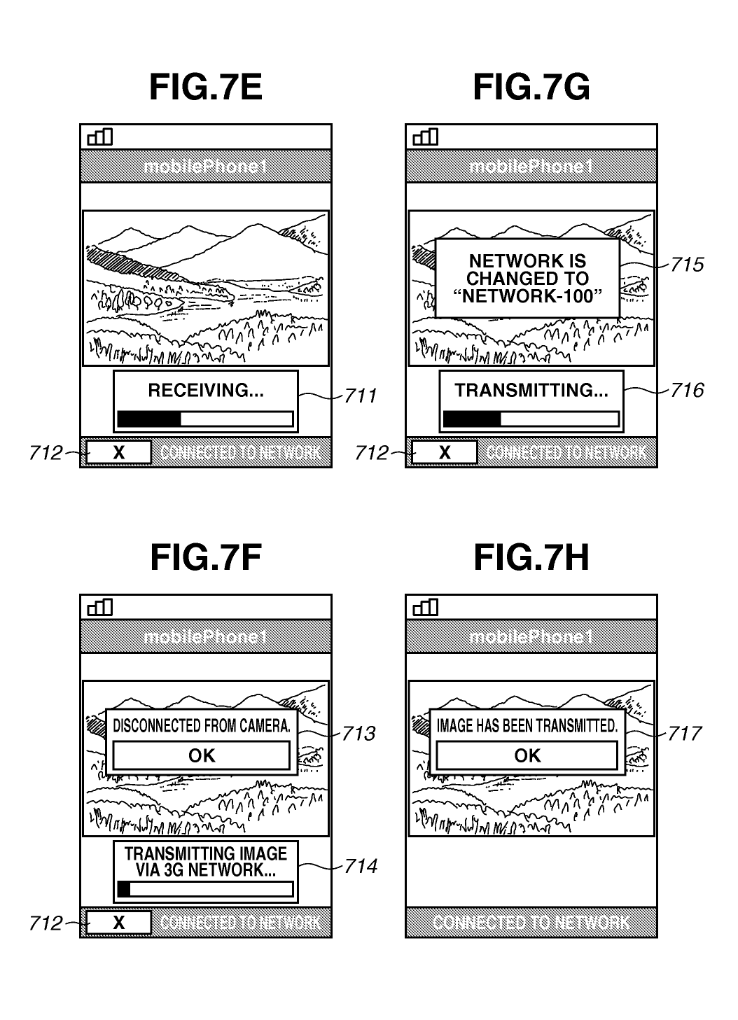

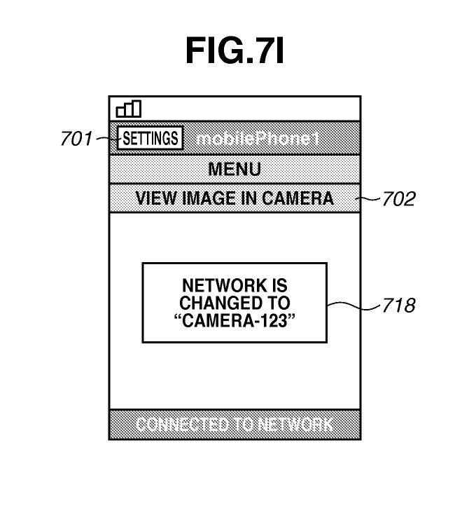

Upon the establishment of the communication with the digital camera 100, the control unit 201 of the mobile phone 200 displays, on the display unit 206, a menu screen of the camera communication application illustrated in FIG. 7A. A settings button 701 and a view button 702 are displayed on the menu screen. The settings button 701 is a button for performing a setting of the device name of the mobile phone 200 and various kinds of settings for upload. The view button 702 is a button for displaying, on the display unit 206, image data stored in the digital camera 100, with which the mobile phone 200 has established the communication.

In step S601, the control unit 201 determines whether the view button 702 is selected. If the control unit 201 determines that the view button 702 is selected (YES in step S601), the processing proceeds to step S602. If the control unit 201 determines that the view button 702 is not selected (NO in step S601), the process is repeated.

In step S602, the control unit 201 requests the digital camera 100 to transmit a thumbnail of the image data stored in the digital camera 100. In response to this request, the digital camera 100 transmits the requested thumbnail to the mobile phone 200. The control unit 201 may repeat requesting a thumbnail one by one, or may transmit a command for collectively requesting a plurality of thumbnails.

In step S603, the mobile phone 200 receives the thumbnail transmitted from the digital camera 100 via the wireless LAN unit 211.

In step S604, the control unit 201 displays, on the display unit 206, the received thumbnail in the form of a list. FIG. 7B illustrates an example of the display screen. In the example illustrated in FIG. 7B, thumbnails are displayed in four columns in a list 703, and other image data can be further displayed by a vertical scrolling operation.

In step S605, the control unit 201 determines whether any thumbnail is selected from the thumbnails displayed in the form of a list. If the control unit 201 determines that a thumbnail is selected (YES in step S605), the processing proceeds to step S606. If no thumbnail is selected (NO in step S605), the processing returns to step S604.

In step S606, the control unit 201 displays the selected thumbnail in an enlarged size. FIG. 7C illustrates an example of this display. As illustrated in FIG. 7C, a selected thumbnail 704 is displayed in a larger size than that illustrated in FIG. 7B. In the present exemplary embodiment, the selected thumbnail is directly enlarged and displayed in step S606, but a larger thumbnail or the image data of this thumbnail itself may be requested again from the digital camera 100, in consideration of the image being displayed in an enlarged size.

Further, the screen illustrated in FIG. 7C includes a reception button 705. The reception button 705 is a button for receiving the image data corresponding to the displayed thumbnail from the digital camera 100, and performing a predetermined process on the received image data. This will be specifically described below.

Upon a selection of the reception button 705 by a user operation, the control unit 201 displays a menu illustrated in FIG. 7D with being translucently-superimposed on the image data. Buttons included in the menu will be described below.

A button 706 is a button for uploading the image data received from the digital camera 100 to a social networking service (SNS) via the Internet. The user of the mobile phone 200 sets the SNS that is an upload destination in advance. Selecting the button 706 starts a process for transmitting the image data to a server provided by the SNS. A process for setting the SNS that is the upload destination may be started in response to the selection of the button 706.

A button 707 is a button for uploading the image data received from the digital camera 100 to a content server. The user of the mobile phone 200 sets the content server that is an upload destination in advance. Selecting the button 707 starts a process for transmitting the image data to the content server via the Internet. A process for setting the content server that is the upload destination may be started in response to the selection of the button 707.

A button 708 is a button for transmitting the image data received from the digital camera 100 by attaching it to an electric mail. Selecting the button 708 causes the control unit 201 to activate an electric mail application and provide a template of an electric mail with the received image data attached thereto. The user of the mobile phone 200 can transmit the electric mail to an arbitrary address via the Internet, after inputting a desired text.

A button 709 is a button for recording the image data received from the digital camera 100 onto the recording medium 210. Selecting the button 709 causes the image data received from the digital camera 100 to be recorded onto the recording medium 210.

A button 710 is a cancel button. Selecting the button 710 deletes the menu illustrated in FIG. 7D, and returns the display to the state illustrated in FIG. 7C.

Subsequently, in step S607, the control unit 201 determines whether any of the buttons 706 to 709 is selected among the buttons illustrated in FIG. 7D. If the control unit 201 determines that any of the buttons 706 to 709 is selected (YES in step S607), the processing proceeds to step S608. If the control unit 201 determines that the button 710 is selected (NO in step S607), the processing returns to step S606.

If the processing proceeds to step S608 (YES in step S607), the control unit 201 requests the digital camera 100 to transmit the image data corresponding to the thumbnail selected in step S605. After the digital camera 100 transmits the image data to the mobile phone 200 in response to the request, the mobile phone 200 receives the image data via the wireless LAN unit 211, and stores the image data into the work memory 204. While the mobile phone 200 is receiving the image data, a screen illustrated in FIG. 7E is displayed on the display unit 206. The screen illustrated in FIG. 7E notifies, through a dialog 711, the user that the image data is currently being received. The user of the mobile phone 200 can cancel the reception by selecting a button 712 illustrated in FIG. 7E.

Upon completion of the reception of the image data, the processing proceeds to step S609, in which the control unit 201 determines what kind of process is selected in step S607. If the control unit 201 determines that any button among the buttons 706 to 708 is selected, that is, determines that an operation of transmitting the received image data to an external destination is selected (TRANSMIT IMAGE TO EXTERNAL DESTINATION in step S609), the processing proceeds to step S611. On the other hand, if the control unit 201 determines that the button 709 is selected, that is, determines that an operation of storing the received image data onto the recording medium 210 without transmitting it to an external destination is selected (STORE IMAGE in step S609), the processing proceeds to step S610.

First, an operation performed if the processing proceeds to step S610 (STORE IMAGE in step S609) will be described. In step S610, the control unit 201 stores the image data received in step S608 from the work memory 204 onto the recording medium 210, and then the processing ends.

Next, an operation performed if the processing proceeds to step S611 (TRANSMIT IMAGE TO EXTERNAL DESTINATION in step S609) will be described. In step S611, the control unit 201 determines whether the network that the mobile phone 200 is currently participating in is created by the simple AP function of the digital camera 100. The control unit 201 makes a determination in the present step by referring to the notification received from the digital camera 100 in step S406 illustrated in FIG. 4. If the control unit 201 determines that the network is not created by the simple AP function of the digital camera 100 (NO in step S611), the processing proceeds to step S612. If the control unit 201 determines that the network is created by the simple AP function of the digital camera 100 (YES in step S611), the processing proceeds to step S613.

First, an operation performed if the processing proceeds from step S611 to step S612 (NO in step S611) will be described. In this case, the control unit 201 determines that the network in which the mobile phone 200 is currently participating is not created by the simple AP function but created by the external AP 300. In other words, the control unit 201 determines that the mobile phone 200 is connected to the digital camera 100 in the manner illustrated in FIG. 3A. In this case, the mobile phone 200 can transmit the image data via the external AP 300. Therefore, the control unit 201 transmits predetermined transmission destination information (a Uniform Resource Locator (URL) or an electric mail address) and the image data received in step S608 to the external AP 300 via the Internet. As a result, the image data is transmitted from the external AP 300 to the predetermined transmission destination.

Next, an operation performed if the processing proceeds from step S611 to step S613 (YES in step S611) will be described with reference to FIG. 6B. In this case, the control unit 201 determines that the mobile phone 200 is currently connected to the digital camera 100 in the manner illustrated in FIG. 3B. In this case, the mobile phone 200 is connected to the network created by the AP, but cannot transmit the image data to an external network via the AP. Therefore, the mobile phone 200 has to switch the network that the mobile phone 200 is currently participating in.

A problem raised here is that some of simple APs of digital cameras or the like automatically delete the created network if there is no device participating in the network for a predetermined time period. Therefore, once a device participating in the network created by the simple AP function leaves the network, the device may be unable to return to the network even if the device tries to return to the original network again, because the network has been already deleted. In view of the foregoing, according to the present exemplary embodiment, when the device participating in the network created by the simple AP temporarily leaves this network, the device requests the digital camera to continue the network created by the simple AP before leaving the network. Then, in response to the request, the digital camera refrains from deleting the network even when detecting a disconnection of the device participating in the created network. This processing will be described below with reference to FIG. 6B.

First, in step S621, the mobile phone 200 transmits a continuation request to cause the digital camera 100 to continue the network created by the simple AP, to the digital camera 100 via the wireless LAN unit 211. If the digital camera 100 receives this request, the digital camera 100 continues the network created by the simple AP function. More specifically, the digital camera 100 refrains from deleting the network even when there is not even a single device participating in the network. As another method for continuing the network, the mobile phone 200 may transmit a request for specifying a time period during which the digital camera 100 is to continue the network. In this case, the digital camera 100 deletes the network created by the digital camera 100 after the time period specified by the request has elapsed.

Subsequently, in step S622, the mobile phone 200 leaves the network that mobile phone 200 is currently participating, and terminates the connection with the AP (the digital camera 100 in the present example). As described above, the digital camera 100 refrains from deleting the network created by the simple AP, since the continuation request is transmitted in advance.

Subsequently, in step S623, the control unit 201 controls the wireless LAN unit 211 to search for a wireless network in the vicinity. Then, in step S624, the control unit 201 determines whether the control unit 201 could detect another wireless network than the network corresponding to the ESSID stored in the work memory 204 in the above-described step S574 (i.e., the external AP 300 other than the simple AP created by the digital camera 100). The control unit 201 determines detection of another wireless network than the network corresponding to the ESSID stored in the work memory 204 at this time for the following purpose. This determination is made so as to distinguish the AP incapable of connecting to the external destination based on the ESSID stored in the work memory 204, since the network corresponding to this stored ESSID is the network of the simple AP created by the digital camera 100 in step S402.

If the control unit 201 could detect the external AP 300 other than the simple AP (YES in step S624), the processing proceeds to step S625. If the control unit 201 could not detect the external AP 300 other than the simple AP (NO in step S624), the processing proceeds to step S626.

If the processing proceeds to step S625 (YES in step S624), the control unit 201 connects to the external AP 300 other than the simple AP created by the digital camera 100. Further, an IP address is assigned and a subnet is set to allow the mobile phone 200 to communicate with another apparatus. Then, the processing proceeds to step S627. The control unit 201 may select the external AP 300 other than the simple AP by storing a wireless parameter of the external AP 300 to which the mobile phone 200 has ever connected previously into the nonvolatile memory 203, and using its history information. In other words, if there is an external AP 300 having the same wireless parameter as the wireless parameter stored in the nonvolatile memory 203 as the history information in a result of the search for a wireless network in step S623, the control unit 201 may connect to this external AP 300.

If the processing proceeds to step S626 (NO in step S624), because the control unit 201 recognizes that the external AP 300 other than the simple AP does not exist in the vicinity of the mobile phone 200, the control unit 201 controls the public network connection unit 212 to connect to the public network. Then, the processing proceeds to step S627. In other words, regardless of whether the processing proceeds to either step S625 or S626, the control unit 201 performs control so as not to connect to the simple AP, to which the mobile phone 200 had been connected.

In step S627, the control unit 201 reads the image data which has been received from the digital camera 100 and then stored in the work memory 204, and controls the wireless LAN unit 211 or the public network connection unit 212 to transmit the image data to the external destination. FIGS. 7F and 7G illustrate screens displayed on the display unit 206 during execution of the process in step S627. The screen illustrated in FIG. 7F is a screen displayed if the processing proceeds to step S627 via step S626 (NO in step S624), and notifies, through a dialog 713, the user of the disconnection from the network created by the digital camera 100, in which the mobile phone 200 had been participating until that time. Further, this screen notifies, through a dialog 714, the user that the image data is being transmitted by another communication method. The screen is configured in this manner for the following reason. If only the dialog 713 is displayed, the user might think that the image data cannot be transmitted without doing a further operation. Therefore, according to the present exemplary embodiment, the mobile phone 200 also displays the dialog indicating that the image data is being transmitted together with the dialog indicating that the mobile phone 200 has been disconnected from the network. The screen illustrated in FIG. 7G is a screen displayed if the processing proceeds to step S627 via step S625 (YES in step S624). This screen notifies, through a dialog 715, the user of a change of the network from the network created by the simple AP to the network “NETWORK-100” created by the external AP 300. Through a dialog 716, this screen further notifies the user that the image data is being transmitted via another network. The screen is configured in this manner so that this screen can indicate to the user which network is used to transmit the image, and the user can cancel the transmission by selecting the button 712 if the user determines that an unintended network is used.

After that, in step S628, the control unit 201 determines whether the transmission process is completed. If the control unit 201 determines that the transmission process is completed (YES in step S628), the processing proceeds to step S629. If the control unit 201 determines that the transmission process is not completed yet (NO in step S628), the process is repeated. FIG. 7H illustrates a screen displayed if the transmission is completed in step S628 (YES in step S628). The screen illustrated in FIG. 7H indicates the image that has been transmitted, and notifies, through a dialog 717, the user of the completion of the transmission of the image.

Upon the completion of the transmission of the image, in step S629, the control unit 201 controls the wireless LAN unit 211 to search for a wireless network in the vicinity. Then, in step S630, the control unit 201 determines whether the control unit 201 could detect the wireless network corresponding to the ESSID stored in the work memory 204 in the above-described step S574 (i.e., the simple AP created by the digital camera 100). If the control unit 201 could detect the network of the simple AP created by the digital camera 100 (YES in step S630), the processing proceeds to step S631. If the control unit 201 could not detect the network of the simple AP created by the digital camera 100 (NO in step S630), the processing ends with the mobile phone 200 remaining connected to the network capable of outward transmission. Since the mobile phone 200 has transmitted, to the digital camera 100, the request for continuation of the network of the simple AP created by the digital camera 100 in step S621, the control unit 201 should be able to detect the network of the simple AP created by the digital camera 100 under normal circumstances. Possible situations leading to a failure to detect this network include, for example, a situation where the digital camera 100 is powered off because the battery thereof runs out.

In step S631, the control unit 201 leaves the currently connected network created by the external AP 300. In step S632, the control unit 201 connects to the network of the simple AP created by the digital camera 100. FIG. 7I illustrates a screen displayed when the mobile phone 200 connects to the network of the simple AP in step S632. The screen illustrated in FIG. 7I notifies, through a dialog 718, the user of a change of the network from the network “NETWORK-100” created by the external AP 300, in which the mobile phone 200 had been participating until that time, to the network “CAMERA-123” created by the digital camera 100. Further, the menu screen for controlling the digital camera 100 is displayed on the display unit 206 together with the display of the dialog 718. This processing allows the mobile phone 200 to connect to the network created by the digital camera 100 again after transmitting the image with use of the external AP 300 or the public network. As a result, the user of the mobile phone 200 can view the image data in the digital camera 100 once again, and even perform an operation for transmitting another image to an external network.

Alternatively, another possible method is to omit the determination in step S611, and leave the network if the mobile phone 200 has failed to transmit the image for a predetermined time period or has failed to transmit the image a predetermined number of times in step S612. However, in this case, it may be highly likely to take a long time until the mobile phone 200 leaves the network, and an amount of communication may also increase. Therefore, it is more desirable that the digital camera 100 notifies, in advance, the mobile phone 200 of whether the network is created by the simple AP.

Further, before transmitting the image data in step S627, the mobile phone 200 may display a screen that allows the user to add a comment and a title to the image data, and perform the settings of the SNS (for example, a range of people whom the image is shared with and a selection of an album).

Further, in the present exemplary embodiment, the processing has been described based on the example in which the mobile phone 200 receives a single image data piece from the digital camera 100, and transmits the single image data piece. However, the user may select a plurality of image data pieces and the mobile phone 200 may receive them, and then sequentially transmit them to the external network. Further, the mobile phone 200 may initially receive the image data, and after that, prompt the user to select which image data should be transmitted from the mobile phone 200.

Further, in the present exemplary embodiment, the mobile phone 200 automatically performs the processing illustrated in FIGS. 6A and 6B without receiving a user operation, unless otherwise indicated especially. However, the mobile phone 200 may be configured to receive a user operation with use of a dialog or the like as necessary.

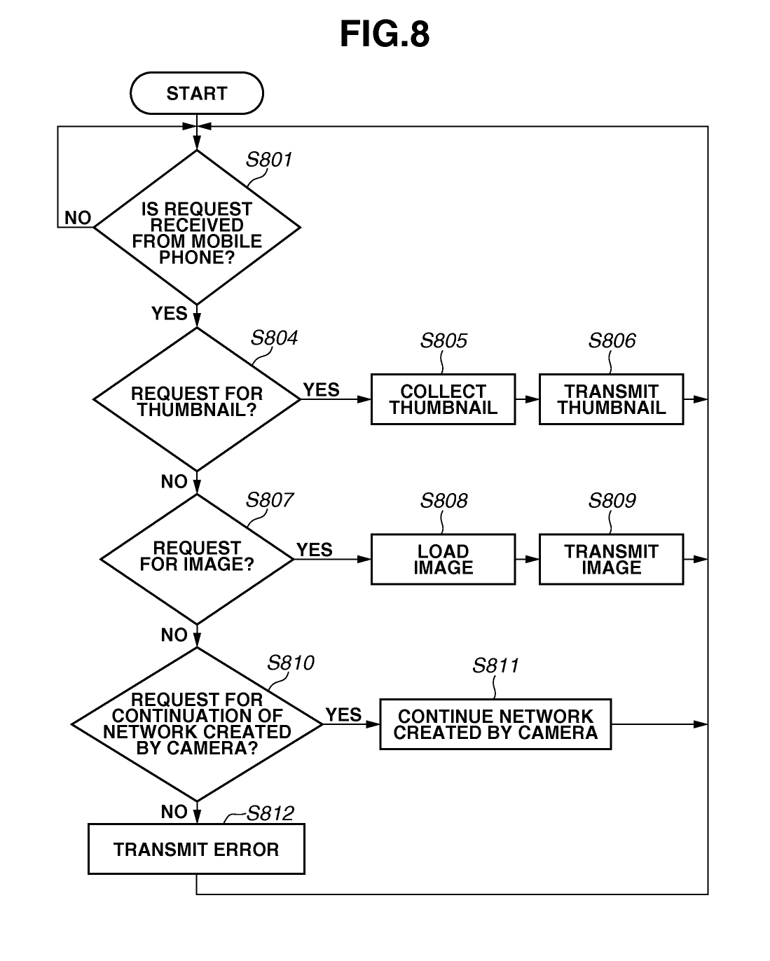

The operation of the mobile phone 200 after connecting to the digital camera 100 has been described above. Next, a detailed operation performed at the digital camera 100 side will be described below. FIG. 8 is a flowchart illustrating an operation of the digital camera 100 after connecting to the mobile phone 200.

In step S801, the control unit 101 of the digital camera 100 determines whether a request is received from the mobile phone 200 via the wireless LAN unit 111. If a request is received (YES in step S801), the processing proceeds to step S804. If no request is received (NO in step S801), the process is repeated. The request that is possibly received at this time is any of the request for the thumbnail that is transmitted in step S602, the request for the image data that is transmitted in steps S607 and S608, and the request for continuation of the network created by the digital camera 100 that is transmitted in step S621.

An operation performed if the processing proceeds to step S804 (YES in step S801) will be described. In step S804, the control unit 101 determines whether the request received in step S801 is the request for the thumbnail (the request transmitted in step S602). If the control unit 101 determines that the received request is the request for the thumbnail (YES in step S804), the processing proceeds to step S805. If the control unit 101 determines that the received request is not the request for the thumbnail (NO in step S804), the processing proceeds to step S807.

First, an operation performed if the processing proceeds to step S805 (YES in step S804) will be described. In step S805, the control unit 101 searches for the image data requested by the mobile phone 200 among image data pieces stored on the recording medium 110, and loads a thumbnail corresponding to the retrieved image data into the work memory 104. Obviously, the control unit 101 can load a plurality of thumbnails. At this time, the control unit 101 may use the thumbnail already associated with the image data, or may additionally generate a new thumbnail.

Subsequently, in step S806, the control unit 101 transmits the thumbnail stored in the work memory 104 to the mobile phone 200 that has requested it, and then the processing returns to step S801. As a result of this process, at the mobile phone 200 side, the thumbnail is received in step S603. This is the process for transmitting the thumbnail from the digital camera 100 to the mobile phone 200.

Next, an operation performed if the processing proceeds to step S807 (NO in step S804) will be described. In step S807, the control unit 101 determines whether the request received in step S801 is the request for the image data corresponding to the thumbnail (the request transmitted in step S607). If the control unit 101 determines that the received request is the request for the image data (YES in step S807), the processing proceeds to step S808. If the control unit 101 determines that the received request is not the request for the image data (NO in step S807), the processing proceeds to step S810.

First, an operation performed if the processing proceeds to step S808 (YES in step S807) will be described. In step S808, the control unit 101 searches for the requested image data from the image data pieces stored on the recording medium 110, and loads the retrieved image data into the work memory 104.

Subsequently, in step S809, the control unit 101 transmits the image data stored in the work memory 104 to the mobile phone 200, and then the processing returns to step S801. As a result of this process, at the mobile phone 200 side, the image data is received in step S608. Among the requests that the digital camera 100 receives from the mobile phone 200, the process for transmitting the image data has been described above.

Further, an operation performed if the processing proceeds to step S810 (NO in step S807) will be described. In step S810, the control unit 101 determines whether the request received in step S801 is the request for continuation of the network created by the simple AP function of the digital camera 100, that is, the request transmitted in step S621. If the control unit 101 determines that the received request is the request for continuation of the network (YES in step S810), the processing proceeds to step S811. If the control unit 101 determines that the received request is not the request for continuation of the network (NO in step S810), the processing proceeds to step S812.

An operation performed if the processing proceeds to step S811 (YES in step S810) will be described. In step S811, the control unit 101 performs a process for refraining from deleting the network even when detecting a disconnection of the device participating in the network created by the simple AP function of the digital camera 100.

On the other hand, if the processing proceeds to step S812 (NO in step S810), the control unit 101 determines that the received request is a request to which the digital camera 100 cannot respond appropriately, and transmits an error notification indicating this fact to the mobile phone 200.

The operation of the digital camera 100 after connecting to the mobile phone 200 has been described above.

### <Overviews of Operations>

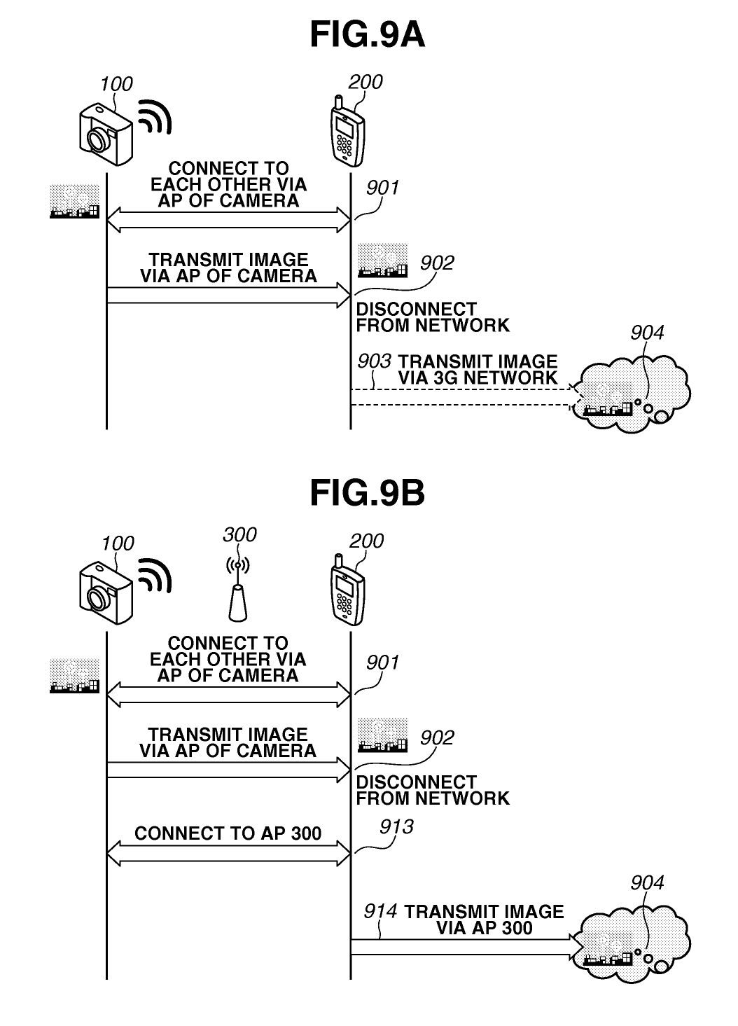

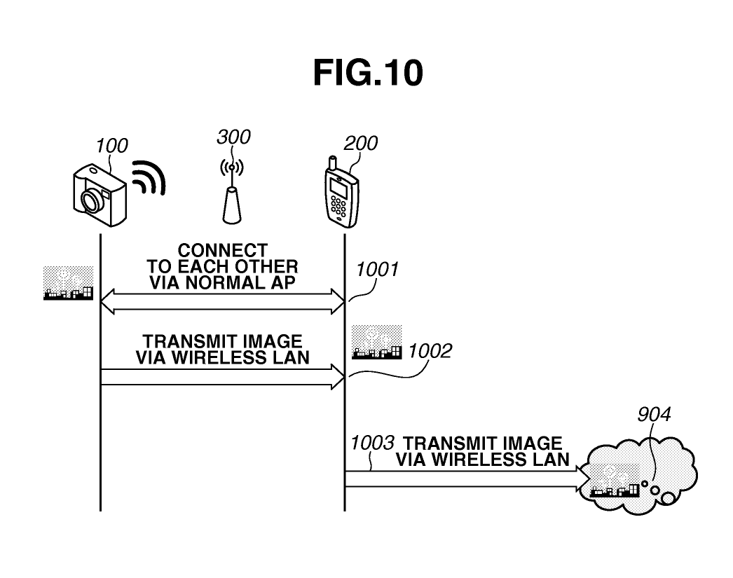

In the following description, an overview of the processing illustrated in FIGS. 6A, 6B, and 8 will be described with reference to FIGS. 9A, 9B, and 10. FIGS. 9A, 9B, and 10 schematically illustrate operations performed when the mobile phone 200 receives the image data stored in the digital camera 100, and transmits the received image data to an Internet 904.

First, an operation performed when the digital camera 100 operates as the AP (step S402 illustrated in FIG. 4) will be described with reference to FIG. 9A. In this case, at a timing 901, the digital camera 100 and the mobile phone 200 participate in the network created by the digital camera 100, and establish communication therebetween. At this time, the mobile phone 200 stores the ESSID of the network created by the digital camera 100 with which the mobile phone 200 has established the communication. Further, the digital camera 100 notifies the mobile phone 200 of whether the current network is created by the digital camera 100 (step S406 illustrated in FIG. 4).

Then, at a timing 902, the digital camera 100 transmits the image data stored in the digital camera 100 to the mobile phone 200 via the wireless LAN network created by the digital camera 100. Then, the mobile phone 200 transmits the received image data to the Internet 904. Since the mobile phone 200 recognizes that the current network is created by the digital camera 100 based on the notification transmitted in advance, at a timing 903, the mobile phone 200 leaves the network created by the digital camera 100, and transmits the image data to the Internet 904 via the public line network with use of the 3G. The overview of the operation performed when the digital camera 100 operates as the AP has been described above.

There is another possible operation performed when the digital camera 100 operates as the AP, which is illustrated in FIG. 9B. In the operation illustrated in FIG. 9B, after leaving the network, at a timing 913, the mobile phone 200 participates in the network created by the external AP 300 if there is the external AP 300 in the vicinity. Then, at a timing 914, the mobile phone 200 transmits the image data to the Internet 904 via the external AP 300. The mobile phone 200 may connect to the external AP 300 at this time by searching for a wireless network, and if there is another wireless network than the network corresponding to the ESSID stored at the timing 901, connecting to this wireless network. The operation illustrated in FIG. 9B has the following advantage: when the digital camera 100 and the mobile phone 200 communicate with each other, in many cases, the communication speed when the digital camera 100 and the mobile phone 200 directly communicate with each other is faster than the communication speed when the digital camera 100 and the mobile phone 200 communicate with each other via the external AP 300. Therefore, it is efficient that the data communication between the digital camera 100 and the mobile phone 200 is performed by direct communication with use of the network created by the digital camera 100, and the mobile phone 200 participates in the network created by the external AP 300 at a timing when it becomes necessary to perform data communication via the Internet 904. In this manner, the mobile phone 200 can transmit data to the Internet 904 by changing the network that the mobile phone 200 participates in from a first network to a second network.

Next, an operation performed when the digital camera 100 and the mobile phone 200 use the network created by the external AP 300 (step S407 illustrated in FIG. 4) will be described with reference to FIG. 10. First, at a timing 1001, the digital camera 100 and the mobile phone 200 participate in the network created by the external AP 300. Then, the digital camera 100 and the mobile phone 200 establish communication therebetween via the external AP 300. Then, at a timing 1002, the digital camera 100 transmits the image data to the mobile phone 200 via the external AP 300, and the mobile phone 200 receives the image data. Then, the mobile phone 200 transmits the received image data to the Internet 904. Since the mobile phone 200 recognizes that the current network is not created by the digital camera 100 based on the notification transmitted in advance, at a timing 1003, the mobile phone 200 transmits the image data to the external AP 300 so that the image data is transmitted to the Internet 904. The overview of the operation performed when the digital camera 100 and the mobile phone 200 use the external AP 300 has been described above.

As described above, the digital camera 100 according to the present exemplary embodiment notifies the mobile phone 200 of whether the network that the mobile phone 200 is currently participating is created with use of the simple AP function of the digital camera 100. Further, the mobile phone 200 stores the ESSID of the network upon the establishment of the communication with the digital camera 100. Then, if the network is created by the simple AP, when transmitting the image data to the external destination, the mobile phone 200 switches the connection to another network than the network corresponding to the stored ESSID, and then transmits the image data. This configuration allows the mobile phone 200 to perform appropriate processing according to the characteristic of the network.

When the network used to connect to the digital camera 100 is the simple AP, the mobile phone 200 may store the ESSID thereof into the nonvolatile memory 203 each time. Then, when transmitting the image data to the external destination after that, the mobile phone 200 may connect to another wireless network than the networks corresponding to the ESSIDs of the simple APs stored in the nonvolatile memory 203. This arrangement allows the mobile phone 200 to establish a wireless connection with a network excluding all simple APs to which the mobile phone 200 has ever connected previously, when transmitting the image data to the external destination. Further, a rule defining how to specify the ESSID of the simple AP created by the digital camera 100 may be determined in advance, and the mobile phone 200 may connect to a wireless network corresponding to an ESSID that does not follow this determined rule when transmitting the image data to the external destination. For example, the rule defining how to specify the ESSID of the simple AP created by the digital camera 100 is determined in such a manner that the ESSID is always named to have “CAMERA” as the first six characters, like “CAMERA-xxx”. Then, the mobile phone 200 connects to a wireless network named to have other characters than “CAMERA” as the first six characters of the ESSID, so that the mobile phone 200 can avoid connecting to the simple AP, when transmitting the image data to the external destination.

Further, according to the present exemplary embodiment, the communication system is configured in such a manner that the user operates the mobile phone 200 to instruct the digital camera 100 to transmit image data to the mobile phone 200, and instruct the mobile phone 200 to transmit image data to the Internet. Alternatively, the communication system may be configured in such a manner that the user operates the digital camera 100 to instruct the digital camera 100 to transmit the image data to the mobile phone 200, and instruct the mobile phone 200 to transmit the image data to the Internet.

Further, according to the present exemplary embodiment, the communication system is configured in such a manner that the digital camera 100 creates the network, and directly communicates with the mobile phone 200. Alternatively, the present invention can be employed even for such a connection configuration that the apparatuses communicate with each other in advance, and one of them operates as the AP, like Wireless Fidelity (Wi-Fi) Direct.

Further, the present exemplary embodiment has been described based on the control of switching the network when the mobile phone 200 transmits the image data received from the digital camera 100 via the Internet, by way of example. However, the application range of the present invention is not limited thereto. For example, if the mobile phone 200 determines that the network in which the mobile phone 200 is currently participating is created by the digital camera 100, the mobile phone 200 may perform similar control when using an application realizable in cooperation with the Internet, such as a web browser and the electric mail application of the mobile phone 200.

The mobile phone 200 according to the first exemplary embodiment has to switch the connection from the network created by the simple AP to the network created by the external AP 300 when transmitting the image data to the Internet or the like. In the first exemplary embodiment, the description has been given of the configuration in which the mobile phone 200 transmits the request for continuation of the network created by the simple AP before switching the connection, so as to thereby continue the network created by the simple AP. However, according to the first exemplary embodiment, the digital camera 100 cannot determine until when the digital camera 100 has to continue the network created by the simple AP since the digital camera 100 has started continuing the network. Especially, when the mobile phone 200 turns off the wireless LAN itself after transmitting the continuation request, for example, the digital camera 100 unnecessarily continues the network, leading to a possibility of increasing power consumption. Especially, when operating as the AP, the digital camera 100 tends to consume more power than when operating as a station, so that this problem becomes remarkable.

In view of the foregoing, according to a second exemplary embodiment, after switching the network to the external network, the mobile phone 200 periodically transmits the continuation request to the digital camera 100 with use of Bluetooth communication, which is usable in parallel with the wireless LAN. Then, the digital camera 100 can determine that the digital camera 100 may immediately delete the network created by the simple AP if no continuation request is transmitted from the mobile phone 200 within a predetermined time period.

In the following description, because the present exemplary embodiment shares many common features with the first exemplary embodiment, the present exemplary embodiment will be described focusing on features peculiar to the present exemplary embodiment while omitting the descriptions of the features common with the first exemplary embodiment. According to the present exemplary embodiment, the wireless LAN network connection is controlled with use of a Bluetooth connection. To realize that, the Bluetooth connection should be established between the digital camera 100 and the mobile phone 200. The Bluetooth connection is established before step S400 illustrated in FIG. 4 at the digital camera 100, and before step S551 illustrated in FIG. 5B-A at the mobile phone 200.

<Operation after Connection>

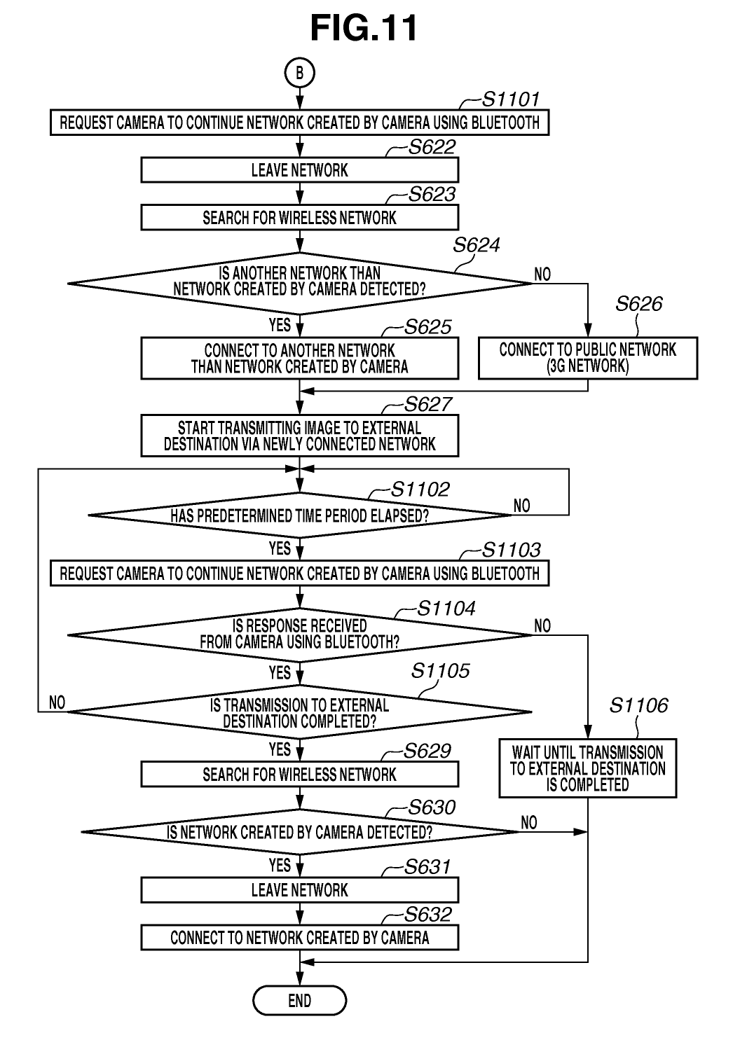

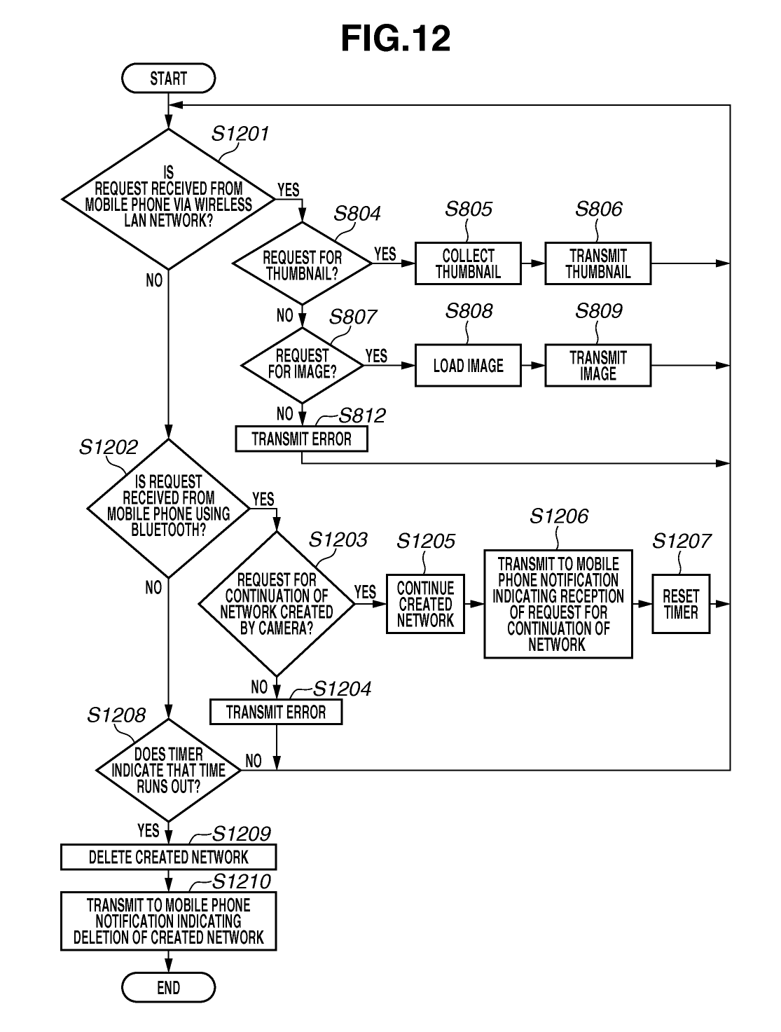

FIG. 11 is a flowchart illustrating an operation of the mobile phone 200 according to the present exemplary embodiment. FIG. 12 is a flowchart illustrating an operation of the digital camera 100 according to the present exemplary embodiment. The flowchart of FIG. 11 illustrates processing performed after the mobile phone 200 connects to the digital camera 100 via a wireless LAN network and also using Bluetooth. In this flowchart, similar processes to the processes illustrated in FIG. 6B are assigned the same step numbers. Differences from the flowchart of FIG. 6B are steps S1101 to S1106. Steps S1101 to S1106 will be described below.

If the control unit 201 determines that the network should be switched to an external network in step S611 illustrated in FIG. 6A, first, in step S1101, the mobile phone 200 transmits the request for continuation of the network created by the simple AP to the digital camera 100 via the Bluetooth unit 215. After that, in step S622, the mobile phone 200 leaves the network created by the simple AP. The mobile phone 200 connects to a new wireless LAN network or the public communication network after that, and the method of the connection is similar to that in the first exemplary embodiment.

In step S627, the control unit 201 reads the image data which has been received from the digital camera 100, and then stored in the work memory 204, and controls the wireless LAN unit 211 or the public network connection unit 212 to transmit the image data to the external destination. If a predetermined time period has elapsed in step S1102 (YES in step S1102), the processing proceeds to step S1103. If the predetermined time period has not elapsed (No in step S1102), the process is repeated. In step S1103, the control unit 201 controls the Bluetooth unit 215 to transmit the request for continuation of the network created by the simple AP to the digital camera 100. If there is no device in the network created by the simple AP for a predetermined time period, the digital camera 100 according to the present exemplary embodiment is configured to determine that the time runs out and delete the network. The mobile phone 200 needs to transmit the request for continuation of the network within this time-out time period. Therefore, the mobile phone 200 periodically transmits the continuation request at a shorter interval than the time-out time period.

In step S1104, the control unit 201 determines whether the Bluetooth unit 215 has received, from the digital camera 100, a response to the request for continuation of the network, which is transmitted from the mobile phone 200 to the digital camera 100 in step S1103. If the Bluetooth unit 215 has received the response (YES in step S1104), the processing proceeds to step S1105. If the Bluetooth unit 215 has not received the response (NO in step S1104), the mobile phone 200 determines that the digital camera 100 is in a state in which the digital camera 100 is unable to perform a wireless connection, so the mobile phone 200 may cancel the transmission of the continuation request. Further, the mobile phone 200 may display this fact on the display unit 206 to notify the user of it. If the Bluetooth unit 215 has not received the response (NO in step S1104), in step S1106, the mobile phone 200 waits until the process for transmitting the image data to the external destination is completed. After the completion, the processing ends with the mobile phone 200 remaining connected to the network capable of outward transmission.

In step S1105, the control unit 201 determines whether the process for transmitting the image data to the external destination is completed. If the process for transmitting the image data to the external destination is completed (YES in step S1105), in step S629, the control unit 201 controls the wireless LAN unit 211 to search for a wireless network in the vicinity. If the transmission is not completed (NO in step S1105), the processing returns to step S1102.

Further, if the Bluetooth unit 215 of the mobile phone 200 receives a notification indicating deletion of the network created by the simple AP after the mobile phone 200 leaves the network created by the simple AP, the mobile phone 200 performs a similar process to the process performed if no response is received in response to the request for continuation of the network in step S1104. This notification indicating the deletion is transmitted from the digital camera 100 in step S1209 of the flowchart illustrated in FIG. 12.

The operation of the mobile phone 200 according to the present exemplary embodiment has been described above.

The flowchart of FIG. 12 illustrates processing performed by the digital camera 100 after the digital camera 100 connects to the mobile phone 200 via the wireless LAN network, and also using Bluetooth. In the flowchart of FIG. 12, processes similar to the processes illustrated in FIG. 8 are assigned the same step numbers. Differences from the flowchart of FIG. 8 are steps S1201 to S1209. Steps S1201 to S1209 will be described below.

In step S1201, the control unit 101 of the digital camera 100 determines whether a request is received from the mobile phone 200 via the wireless LAN unit 111. If a request is received (YES in step S1201), the processing proceeds to steps S804, and then, S805 or S807, and S808 or S812, in which the respective processes are performed. After completion of these processes, the processing returns to step S1201. If no request is received via the wireless LAN unit 111 (NO in step S1201), the processing proceeds to step S1202.

In step S1202, the control unit 101 of the digital camera 100 determines whether a request is received from the mobile phone 200 via the Bluetooth unit 112. If a request is received (YES in step S1202), the processing proceeds to step S1203. If no request is received (NO in step S1202), the processing proceeds to step S1208. In step S1203, the control unit 101 of the digital camera 100 determines whether the request for continuation of the network created by the digital camera 100 is received. If the continuation request is received (YES in step S1203), the processing proceeds to step S1205. If the continue request is not received (NO in step S1203), the processing proceeds to step S1204. If the processing proceeds to step S1204 (NO in step S1203), the control unit 101 determines that the received request is a request to which the digital camera 100 cannot respond appropriately, and transmits an error notification indicating this fact to the mobile phone 200. After that, the processing returns to step S1201.

The digital camera 100 defines how long the digital camera 100 is to continue the network if the digital camera 100 detects a disconnection of the device from the created network. The control unit 101 measures a time period elapsed since the mobile phone 200 leaves the created network with use of a timer. If the control unit 101 receives the request for continuation of the created network from the mobile phone 200 before the time runs out, the control unit 101 resets the timer, and starts measuring the time period again. Further, if the mobile phone 200 participates in the network created by the digital camera 100 again to establish a connection before the time runs out, the control unit 101 also resets the timer.

In step S1205, the control unit 101 of the digital camera 100 performs the process for continuing the network created by the digital camera 100. After that, in step S1206, the digital camera 100 transmits a notification indicating reception of the continuation request to the mobile phone 200 via the Bluetooth unit 112. In step S1207, the control unit 101 of the digital camera 100 resets the timer. Then, the processing returns to step S1201.

In step S1208, the control unit 101 of the digital camera 100 determines whether the predetermined time period has elapsed since the mobile phone 200 leaves the network created by the digital camera 100 with use of the timer. If the timer indicates that the time runs out (YES in step S1208), the processing proceeds to step S1209. If the time does not run out yet (NO in step S1208), the processing returns to step S1201. In step S1209, the control unit 101 of the digital camera 100 determines that the network created by the digital camera 100 becomes unnecessary, and deletes the network. At this time, the digital camera 100 may display this fact on the display unit 106 of the digital camera 100 to notify the user of it. In step S1210, the control unit 101 of the digital camera 100 transmits the notification indicating the deletion of the network created by the digital camera 100 to the mobile phone 200 via the Bluetooth unit 112.

The operation of the digital camera 100 after connecting to the mobile phone 200 according to the present exemplary embodiment has been described above.

As described above, according to the present exemplary embodiment, the mobile phone 200 can periodically transmit the continuation request by using Bluetooth, even after leaving the network created by the simple AP. Further, the mobile phone 200 can detect the state of the digital camera 100 by receiving the notification indicating the reception of the request for continuation of the network and the notification indicating the deletion of the network from the digital camera 100 with use of the Bluetooth connection.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-207012 filed Oct. 2, 2013, which is hereby incorporated by reference herein in its entirety.

What is claimed is:

1. A communication apparatus comprising:
a unit configured to establish communication with a data processing apparatus via a first network created by the data processing apparatus;
a receiving unit configured to receive an instruction to transmit data to an external apparatus different from the data processing apparatus after the communication with the data processing apparatus is established;
a transmission unit configured to transmit, to the data processing apparatus, a notification for terminating the communication with the data processing apparatus and a notification for causing the data processing apparatus to continue the first network, if the instruction is received by the receiving unit; and
a unit configured to establish communication with the external apparatus via a second network after the communication with the data processing apparatus is terminated.

2. The communication apparatus according to claim 1, wherein the first network is deleted in a case where a predetermined time period has elapsed since the notification for causing the data processing apparatus to continue the first network is transmitted and if predetermined communication is not performed between the data processing apparatus and the communication apparatus.

3. The communication apparatus according to claim 1, wherein the notification for causing the data processing apparatus to continue the first network is transmitted not via the first network.

4. The communication apparatus according to claim 3,
wherein the first network is a network based on a wireless local area network, and
wherein the notification for causing the data processing apparatus to continue the first network is transmitted using Bluetooth.

5. The communication apparatus according to claim 4, wherein the notification for causing the data processing apparatus to continue the first network is transmitted using Bluetooth Low Energy.

6. The communication apparatus according to claim 1, wherein the instruction to transmit data to the external apparatus different from the data processing apparatus is an instruction to transmit data to the external apparatus via the Internet.

7. The communication apparatus according to claim 1, wherein the first network is created by the data processing apparatus operating as an access point of a wireless local area network.

8. The communication apparatus according to claim 1, wherein the data processing apparatus is an imaging apparatus.

9. The communication apparatus according to claim 1, wherein the communication apparatus is a mobile phone.

10. A control method of a communication apparatus, the control method comprising:
establishing communication with a data processing apparatus via a first network created by the data processing apparatus;
receiving an instruction to transmit data to an external apparatus different from the data processing apparatus after the communication with the data processing apparatus is established;
transmitting, to the data processing apparatus, a notification for terminating the communication with the data processing apparatus and a notification for causing the data processing apparatus to continue the first network, if the instruction is received; and
establishing communication with the external apparatus via a second network after the communication with the data processing apparatus is terminated.

11. A computer-readable recording medium storing a program that causes a computer to function as the communication apparatus according to claim 1.
